(19) United States
(12) Patent Application Publication
(10) Pub. No.: US 2026/0121538 A1
(43) Pub. Date: Apr. 30, 2026

(54) SINGLE-STAGE NON-ISOLATED BUCK CONVERTER WITH HIGH CONVERSION RATIO

(71) Applicant: National Taiwan University of Science and Technology, Taipei City (TW)

(72) Inventors: HUANG-JEN CHIU, New Taipei City (TW); Dinh Phuc Nguyen, Taipei City (TW); Anh Dung Nguyen, Hayward, CA (US)

(21) Appl. No.: 19/018,266

(22) Filed: Jan. 13, 2025

(30) Foreign Application Priority Data
Oct. 28, 2024 (TW) 113140977

(51) Int. Cl. H02M 3/158; H02M 3/06

(52) U.S. Cl. CPC H02M 3/1582; H02M 3/06

(57) ABSTRACT

A single-stage non-isolated buck converter with high conversion ratio is provided. The single-stage non-isolated buck converter includes an input capacitor, an output capacitor, a main inductor, a first switch circuit, a plurality of second switch circuits, a third switch circuit and a switch control circuit. The first switch circuit includes a first high-side switch, a first clamping capacitor and a first low-side switch. A plurality of second switch circuits each includes a second high-side switch, a second clamping capacitor, a first additional inductor and a second low-side switch. The switch control circuit is configured to control the first high-side switch, the first low-side switch, the second high-side switches and the second low-side switches to be turned on and off in a plurality of operating modes.

### CROSS-REFERENCE TO RELATED PATENT APPLICATION

This application claims the benefit of priority to Taiwan Patent Application No. 113140977, filed on Oct. 28, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a direct current (DC) power converter, and more particularly to a single-stage non-isolated buck converter with a high conversion ratio.

### BACKGROUND OF THE DISCLOSURE

The widespread adoption of cloud computing and the advancement of various Internet services have significantly increased the energy consumption of data centers, necessitating ongoing enhancements in efficiency at both the system and converter levels. In data centers, the central processing unit (CPU), the graphic processing unit (GPU), and the DDR components rely on well-regulated DC voltage provided by voltage regulator modules (VRMs). Current trends in the VRMs for microprocessors involve the adoption of 48V or 12V DC buses. To reduce distribution loss, improve efficiency, and achieve greater deployment flexibility, the 48V DC bus voltage structure for data centers has garnered more attention due to the significant transmission losses associated with the existing 12V DC bus voltage.

As a widely used converter, the 48V DC bus VRM features several different topologies. One of the most popular solutions for 48V to 1.xV conversion involves cascading two converters: a first stage steps down the unregulated 48V to 12V, followed by a second stage that converts 12V to 1.xV. Typically, the first stage, which steps down from 48V to 12V, is primarily used for maintaining efficiency. The second stage, converting from 12V to 1.xV, utilizes multiphase interleaved buck converters to deliver high current (tens of amps) to the CPU and reduce the output filter volume, while maintaining relatively good efficiency across a wide load range.

However, the overall efficiency of a two-stage converter is typically constrained by the combined efficiencies of both stages, especially at light and maximum loads. Additionally, the first stage, operating at a higher output voltage or lower frequency, uses large-sized passive components, which reduces power density.

Therefore, the single stage converter has recently been gaining more traction and widespread application. Conventional buck converters are unsuitable for this single-stage application due to the extremely small duty cycle that is required. For instance, a conventional half-bridge buck converter requires generating a 1/48 duty ratio. Due to the extremely low duty ratio required, achieving an accurate duty cycle is crucial. Any delay in the feedback loop can lead to significant output regulation distortions and potentially cause load shutdown.

Additionally, the significant voltage difference between the input and output of the converter results in high voltage stress on power switches, which increases switching loss and restricts the selection of power switches with a poorer figure-of-merit (RON*QR). Therefore, in order to address these challenges, there is a need for further development on topologies with high voltage gain.

### SUMMARY OF THE DISCLOSURE

In response to the above-referenced technical inadequacies, the present disclosure provides a single-stage non-isolated buck converter with a high conversion ratio.

In order to solve the above-mentioned problems, one of the technical aspects adopted by the present disclosure is to provide a single-stage non-isolated buck converter, including an input capacitor, an output capacitor, a first switching circuit, one or more second switch circuits, a third switch circuit and a switch control circuit. The first end and a second end of the input capacitor are respectively connected to a first end and a second end of an input power source. A first end and a second end of the output capacitor are respectively connected to a first end and a second end of a load. The main inductor is connected between a common node and the first end of the output capacitor. The first switching circuit includes a first high-side switch, a first clamping capacitor and a first low-side switch. A first end of the first high-side switch is connected to the first end of the input capacitor. The first clamping capacitor is connected between the second end of the first high-side switch and the common node. The first low-side switch is connected between the common node and the second end of the output capacitor. The one or more second switch circuits each include a second high-side switch, a second clamping capacitor, a first additional inductor and a second low-side switch. The second high-side switch has a first end and a second end and is connected between the second end of the first high-side switch and the common node. A first end of the second clamping capacitor is connected to the second end of the second high-side switch. A first end and a second end of the first additional inductor are respectively connected to the second end of the second clamping capacitor and the common node. The second low-side switch is connected between the first end of the first additional inductor and the second end of the output capacitor. The third switch circuit includes a third high-side switch, a third low-side switch, a second additional inductor and a switch control circuit. A first end of the third high-side switch is connected to the second end of one of the second high-side switches. A first end and a second end of the third low-side switch are respectively connected to the second end of the third high-side switch and the second end of the output capacitor. A first end of the second additional inductor is connected to the second end of the third high-side switch, the first end of the third low-side switch and the common node. The switch control circuit is configured to control the first high-side switch, the first low-side switch, each of the second high-side switches, each of the second low-side switches, the third high-side switch, and the third low-side switch to be turned on and off in a plurality of operating modes.

Therefore, in the single-stage non-isolated buck converter, compared with the switch network of the traditional buck converter, clamping capacitors are added to reduce the voltage stress on the switches and the input voltage. In addition to the main inductor that transfers energy to the output, additional inductors are used to alleviate the burden on the clamping capacitors. Switch selection remains manageable even at high voltage gains, and the voltage stress on these switches can be controlled by adjusting an order of the switch network. Additionally, the use of low-voltage switches, which do not require high voltage tolerance, results in smaller on-resistance and thus reduces conduction losses. Furthermore, under high voltage gain requirements, compliance can be achieved by increasing the order of the switch network.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit diagram of a single-stage non-isolated buck converter according to one embodiment of the present disclosure;

FIGS. 2A and 2B show switching signal waveforms of all switch components and signal timing diagrams of voltage stress, inductor voltages, and inductor currents in the single-stage non-isolated buck converter according to one embodiment of the present disclosure;

FIG. 3 is a schematic diagram showing current flow paths of the single-stage non-isolated buck converter in a first phase according to one embodiment of the present disclosure;

FIG. 4 is a schematic diagram showing current flow paths of the single-stage non-isolated buck converter in second, fourth, sixth and eighth phases according to one embodiment of the present disclosure;

FIG. 5 is a schematic diagram showing current flow paths of the single-stage non-isolated buck converter in a third phase according to one embodiment of the present disclosure;

FIG. 6 is a schematic diagram showing current flow paths of the single-stage non-isolated buck converter in a fifth phase according to one embodiment of the present disclosure;

FIG. 7 is a schematic diagram showing current flow paths of the single-stage non-isolated buck converter in a seventh phase according to one embodiment of the present disclosure;

FIG. 8 is a circuit diagram of a single-stage non-isolated buck converter according to another embodiment of the present disclosure; and

FIG. 9 is a circuit diagram of a single-stage non-isolated buck converter according to yet another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

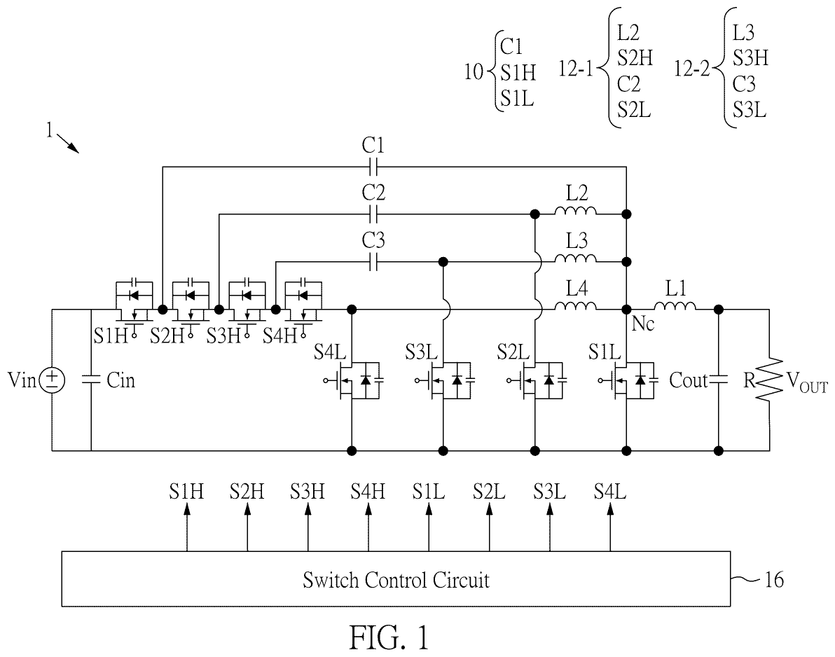

FIG. 1 is a circuit diagram of a single-stage non-isolated buck converter according to one embodiment of the present disclosure. Referring to FIG. 1, the present embodiment provides a single-stage non-isolated buck converter 1, which includes an input capacitor Cin, an output capacitor Cout, a main inductor L1, a first switch circuit 10, second switch circuits 12-1, 12-2, a third switch circuit 14 and a switch control circuit 16.

A first end and a second end of the input capacitor Cin are respectively connected to a first end and a second end of the input power source Vin.

A first end and a second end of the output capacitor Cout are respectively connected to a first end and a second end of the load R. The main inductor L1 is connected between a common node Nc and a first end of the output capacitor Cout.

The first switch circuit 10 includes a high-side switch S1H, a clamping capacitor C1, and a low-side switch S1L. A first end of the high-side switch S1H is connected to the first end of the input capacitor Cin. The clamping capacitor C1 is connected between a second end of the high-side switch S1H and the common node Nc. The low-side switch S1L is connected between the common node Nc and the second end of the output capacitor Cout.

The second switch circuit 12-1 includes a high-side switch S2H, a clamping capacitor C2, an additional inductor L2, and a low-side switch S2L. The high-side switch S2H has a first end and a second end, and is connected between the second end of the high-side switch S1H and the common node Nc. More specifically, a first end of the high-side switch S2H is connected to a second end of the high-side switch S1H and the clamping capacitor C1, and a second end of the high-side switch S2H is connected to a first end of the clamping capacitor C2. A first end and a second end of the additional inductor L2 are respectively connected to the second end of the clamping capacitor C2 and the common node Nc. The low-side switch S2L is connected between the second end of the additional inductor L2 and the second end of the output capacitor Cout.

The single-stage non-isolated buck converter 1 further includes another second switch circuit 12-2, which includes a high-side switch S3H, a clamping capacitor C3, an additional inductor L3 and a low-side switch S3L. The high-side switch S3H has a first end and a second end, and is connected between the second end of the high-side switch S2H and the common node Nc. More specifically, the first end of the high-side switch S3H is connected to the second end of the high-side switch S2H and the first end of the clamping capacitor C2, and the second end of the high-side switch S3H is connected to a first end of the clamp capacitor C3. A first end and a second end of the additional inductor L3 are respectively connected to a second end of the clamping capacitor C3 and the common node Nc. The low-side switch S3L is connected between the second end of the additional inductor C3 and the second end of the output capacitor Cout.

It should be noted that a quantity (e.g., two) of the second switch circuits 12-1 and 12-2 in FIG. 1 is only an example. The quantity of the second switch circuits can be m, where m is a positive integer greater than zero. When the quantity of the second switch circuits is plural, multiple high-side switches therein can be connected in sequence between the high-side switch S1H and the common node Nc.

On the other hand, the third switch circuit 14 includes a high-side switch S4H, a low-side switch S4L and an additional inductor L4. A first end of the high-side switch S4H is connected to the second end of the high-side switch S3H of the last second switch circuit 12-2. A first end and a second end of the low-side switch S4L are connected to the second end of the high-side switch S3H and the second end of the output capacitor Cout, respectively. A first end of the additional inductor L4 is connected to a second end of the high-side switch S4H, the first end of the low-side switch S4L and the common node Nc.

To achieve high voltage conversion ratios in isolated high-step-down DC-DC topologies, it is essential to consider transformers with a high turns ratio and high operating frequency. However, due to efficiency limitations from light load to full load, the relatively large and complex custom transformers, the expensive printed circuit boards (PCBs) and control complexity, non-isolated topologies are an excellent choice that has gained attention for their simple structures and high power density.

As can be seen from the circuit structure of FIG. 1, compared to the switch network of the conventional buck converter, the single-stage non-isolated buck converter 1 of the present embodiment adds clamping capacitors C1, C2, and C3 to reduce voltage stresses on the switches and the input voltage. In addition to the main inductor L1 that transfers energy to the output side, the additional inductors L2, L3, L4 also help to relieve the burden on the clamping capacitors C1, C2, C3.

The switch control circuit 16 can provide multiple sets of switch signals to control the high-side switches S1H, S2H, S3H, S4H and the low-side switches SIL, S2L, S3L, S4L to turn on and off in multiple working modes. Switch selection remains manageable even at high voltage gains, and the voltage stress on these switches can be controlled by adjusting an order of the switch network. Additionally, the use of low-voltage switches, which do not require high voltage tolerance, results in smaller on-resistance and thus reduces conduction losses. Furthermore, under high voltage gain requirements, compliance can be achieved by increasing the order of the switch network.

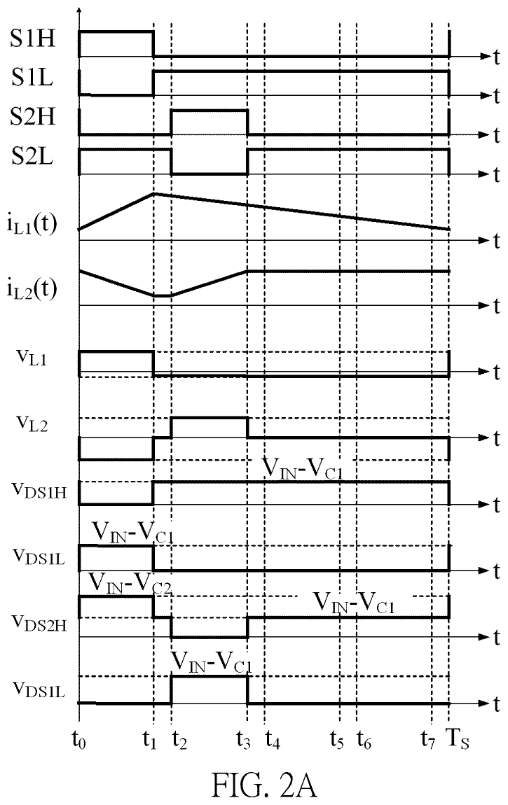

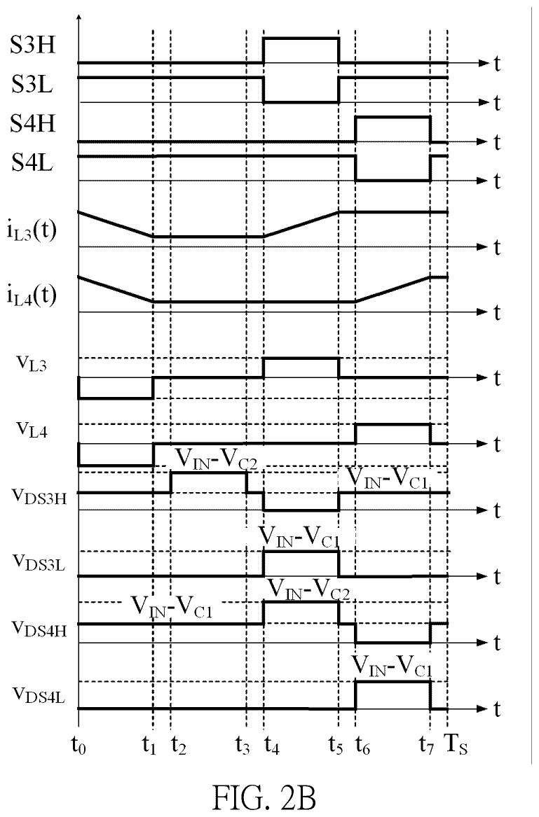

FIGS. 2A and 2B show switching signal waveforms of all switch components and signal timing diagrams of voltage stress, inductor voltages, and inductor currents in the single-stage non-isolated buck converter according to one embodiment of the present disclosure. Referring to FIGS. 2A and 2B, a detailed explanation of the operating principles of the single-stage non-isolated buck converter 1 in the present embodiment is provided hereinafter. A duty cycle of the high-side switches S1H, S2H, S3H, and S4H is denoted as D, while the on-time of the low-side switches SIL, S2L, S3L, and S4L is 1-DTS, where TS is a switching period and fS is a switching frequency. It should be noted that the duty cycle is less than 0.25 and the converter operates in CCM. If an order of the switch network is N, the duty cycle is limited to 1/N. To simplify the analysis of the single-stage non-isolated buck converter 1, the following assumptions are made:

1. The switches are assumed to be ideal components.

2. Four gate drivers S1H, S2H, S3H and S4H are phase-shifted by 90° from one another, and the switches S1L, S2L, S3L and S4L are complementary switches of the gate drivers S1H, S2H, S3H and S4H, respectively.

3. Capacitances of the clamping capacitors C1, C2, and C3 are the same and large enough to keep the voltage across each of them constant without voltage ripples.

4. The single-stage non-isolated buck converter operates in continuous current mode (CCM) with the duty cycle D being smaller than 0.25. A more detailed analysis of each mode can be made with reference to FIGS. 2A and 2B, where there are eight operating phases.

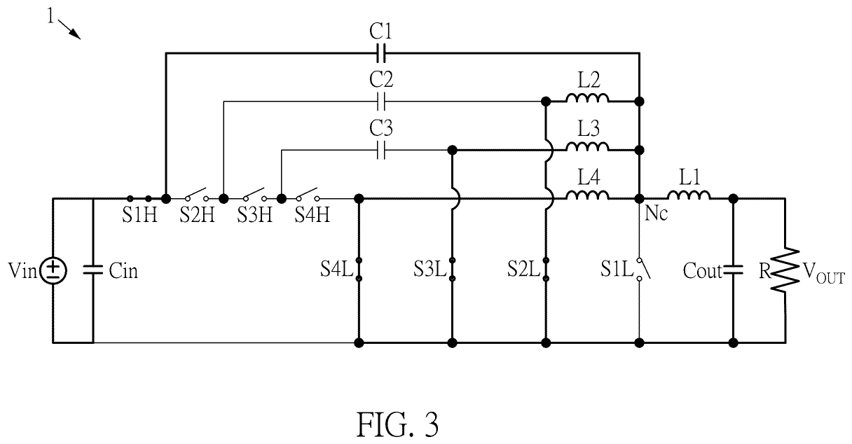

FIG. 3 is a schematic diagram showing current flow paths of the single-stage non-isolated buck converter in a first phase according to one embodiment of the present disclosure.

The first phase (time t0 to t1): during this period of time, the switch control circuit 16 enters the first operating mode, the high-side switch S1H is turned on, and the low-side switch S1L is turned off. The high-side switches S2H, S3H, and S4H are turned off, while the low-side switches S2L, S3L, and S4L are turned on, as shown in FIG. 3. The input voltage VIN of the input power source Vin passes through the clamping capacitor C1, the main inductor L1 and the load R, thereby charging the clamp capacitor C1 and magnetizing the main inductor L1. The main inductor L1 is magnetized by a voltage obtained by subtracting a clamping capacitor voltage VC1 and the output voltage VOUT from the input voltage VIN, and the additional inductors L2, L3, and L4 are demagnetized by a voltage obtained from subtracting the input voltage VIN from the clamping capacitor voltage VC1, as shown in the following equations (1) to (7):

$${v}_{L 1} = {L}_{1} \frac{d {i}_{L 1}}{d t} = {V}_{IN} - {V}_{C 1} - {V}_{OUT} ; \qquad ( 1 )$$

$${v}_{L 2} = {L}_{2} \frac{d {i}_{L 2}}{d t} = - {V}_{IN} + {V}_{C 1} ; \qquad ( 2 )$$

$${v}_{L 3} = {L}_{3} \frac{d {i}_{L 3}}{d t} = - {V}_{IN} + {V}_{C 1} ; \qquad ( 3 )$$

$${v}_{L4} = {L}_{4} \frac{d {i}_{L4}}{d t} = - {V}_{IN} + {V}_{C 1} ; \qquad ( 4 )$$

$${i}_{C 1} = {C}_{1} \frac{{dv}_{C 1}}{d t} = {i}_{L 1} - {i}_{L 2} - {i}_{L 3} - {i}_{L 4} ; \qquad ( 5 )$$

$${i}_{C 2} = {C}_{2} \frac{{dv}_{C 2}}{d t} = 0 ; \qquad ( 6 )$$

$${i}_{C 3} = {C}_{3} \frac{{dv}_{C 3}}{d t} = 0 ; \qquad ( 7 )$$

where v_{L1}, v_{L2}, v_{L3}, v_{L4} are inductor voltages of the main inductor L1 and the additional inductor L2, L3, and L4, respectively, L₁, L₂, L₃, L₄ are inductances of the main inductor L1 and the additional inductor L2, L3, and L4 respectively, i_{L1}, i_{L2}, i_{L3}, i_{L4} are inductor currents of the main inductor L1 and the additional inductor L2, L3, and L4, respectively, C₁, C₂, C₃ are capacitances of the clamping capacitors C1, C2, and C3, respectively, dv_{C1}, dv_{C2}, dv_{C3} are voltage changes on the clamping capacitors C1, C2, and C3, respectively, V_{C1} is the clamping capacitor voltage of the clamping capacitor C1, and i_{C1}, i_{C2}, i_{C3} are currents on the clamping capacitors C1, C2, and C3.

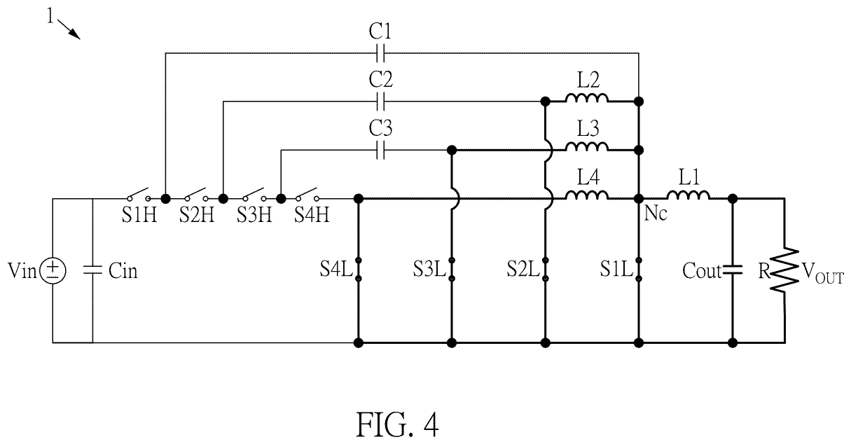

FIG. 4 is a schematic diagram showing current flow paths of the single-stage non-isolated buck converter in second, fourth, sixth and eighth phases according to one embodiment of the present disclosure.

The second, fourth, sixth and eighth phases (time t1-t2, time t3-t4, time t5-t6, time t7-TS): as shown in FIG. 4, during this time interval, the switch control circuit 16 enters a second operating mode, the high-side switches S1H, S2H, S3H and S4H are turned off, and the low-side switches S1L, S2L, S3L and S4L are turned on. The main inductor L1 is demagnetized by the negative output voltage VOUT, the voltage stress on the additional inductors L2, L3, and L4 becomes zero, and then the inductor currents i_{L2}, i_{L3}, i_{L4} circulate. The clamping capacitors C1, C2, and C3 are not conducted at this time, as shown in equations (8) to (11):

$${v}_{L 1} = {L}_{1} \frac{d {i}_{L 1}}{d t} = - {V}_{OUT} ; \qquad ( 8 )$$

$${v}_{L 2} = {L}_{2} \frac{d {i}_{L 2}}{d t} = 0 ; \qquad ( 9 )$$

$${v}_{L 3} = {L}_{3} \frac{d {i}_{L 3}}{d t} = 0 ; \qquad ( 10 )$$

$${v}_{L 4} = {L}_{4} \frac{d {i}_{L 4}}{d t} = 0 ; \qquad ( 11 )$$

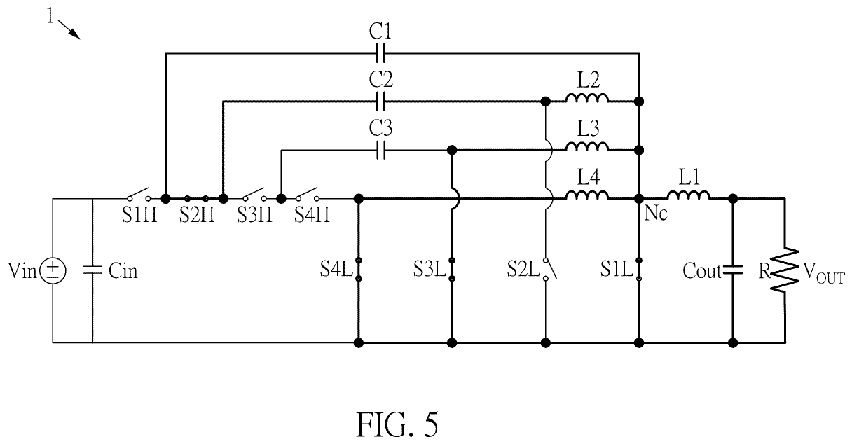

FIG. 5 is a schematic diagram showing current flow paths of the single-stage non-isolated buck converter in a third phase according to one embodiment of the present disclosure.

It should be noted that when a quantity of the second switch circuits is m, high-side switches S2H, S3H to SmH and low-side switches S2L, S3L to SmL are provided, and the operating modes include m third operating modes. In a n-th third operating mode among the m third operating modes, the switch control circuit 16 controls the high-side switch S1H to be turned off, the low-side switch SIL to be turned on, the n-th high-side switch (for example, the high-side switch SnH among the high-side switches S2H, S3H to SmH) to be turned on, the remaining high-side switches to be turned off, the n-th low-side switch (for example, the low-side switch SnL among the low-side switches S2L, S3L to SmL, n is 1 to m) to be turned off, and the remaining low-side switches to be turned off. Furthermore, the high-side switch in the third switching circuit 14 is turned off, and the low-side switch in the third switching circuit 14 is turned on. In the following descriptions, m is assumed to be 2.

The third phase (time t2-t3): as shown in FIG. 5, during this time interval, the switch control circuit 16 enters a first one of third operating modes, the high-side switch S2H is turned on, and the high-side switches S1H, S3H, and S4H are turned off. On the other hand, the low-side switch S2L is turned off, and the low-side switches SIL, S3L, and S4L are turned on. The main inductor L1 is continuously demagnetized by the voltage −VOUT, the voltage stress on the additional inductors L3, L4 is zero, and then these currents circulate. The clamping capacitors C1 and C2 charge the inductor L2 as shown in equations (12) to (17):

$${v}_{L 1} = {L}_{1} \frac{d {i}_{L 1}}{d t} = - {V}_{OUT} ; \qquad ( 12 )$$

$${v}_{L 2} = {L}_{2} \frac{d {i}_{L 2}}{d t} = {V}_{C 1} - {V}_{C 2} ; \qquad ( 13 )$$

$${v}_{L 3} = {L}_{3} \frac{d {i}_{L 3}}{d t} = 0 ; \qquad ( 14 )$$

$${v}_{L 4} = {L}_{4} \frac{d {i}_{L 4}}{d t} = 0 ; \qquad ( 15 )$$

$${i}_{C 1} = {C}_{1} \frac{{dv}_{C 1}}{d t} = - {i}_{L 2} ; \qquad ( 16 )$$

$${i}_{C 2} = {C}_{2} \frac{{dv}_{C 2}}{d t} = {i}_{L 2} ; \qquad ( 17 )$$

where V_{C2} is the clamping capacitor voltage of the clamping capacitor C2. After the third phase (time t2-t3) ends, the fourth phase as shown in FIG. 4 is entered into, and the switch control circuit 16 enters the second operating mode.

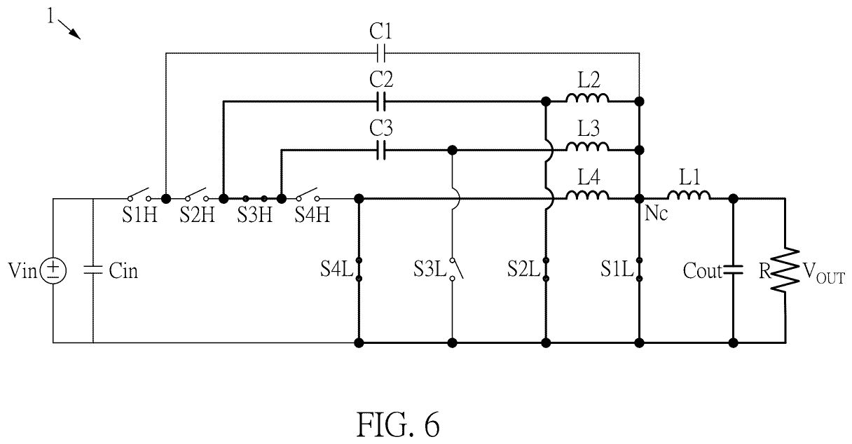

FIG. 6 is a schematic diagram showing current flow paths of the single-stage non-isolated buck converter in a fifth phase according to one embodiment of the present disclosure.

The fifth phase (time t4-t5): as shown in FIG. 6, during this time interval, the switch control circuit 16 enters a second one of the third operating modes, the high-side switch S3H is turned on, and the high-side switches S1H, S2H, and S4H are turned off. At the same time, the low-side switch S3L is turned off, and the low-side switches SIL, S2L, and S4L are turned on. The main inductor L1 is kept at the negative output voltage VOUT, the voltage stress on the additional inductors L2, L4 is zero, and then these currents circulate. The clamping capacitors C2 and C3 charge the additional inductor L3, and the clamping capacitor C1 is off, as shown in the following equations (18) to (23):

$${v}_{L 1} = {L}_{1} \frac{d {i}_{L 1}}{d t} = - {V}_{OUT} ; \qquad ( 18 )$$

$${v}_{L 2} = {L}_{2} \frac{d {i}_{L 2}}{d t} = 0 ; \qquad ( 19 )$$

$${v}_{L 3} = {L}_{3} \frac{d {i}_{L 3}}{d t} = {V}_{C 2} - {V}_{C 3} ; \qquad ( 20 )$$

$${v}_{L 4} = {L}_{4} \frac{d {i}_{L 4}}{d t} = 0 ; \qquad ( 21 )$$

$${i}_{C 2} = {C}_{2} \frac{{dv}_{C 2}}{d t} = - {i}_{L 3} ; \qquad ( 22 )$$

$${i}_{C 3} = {C}_{3} \frac{{dv}_{C 3}}{d t} = {i}_{L 3} ; \qquad ( 23 )$$

where V_{C3} is the clamping capacitor voltage of the clamping capacitor C3. After the fifth phase (time t4-t5) ends, the sixth phase as shown in FIG. 4 is entered, and the switch control circuit 16 enters the second operating mode.

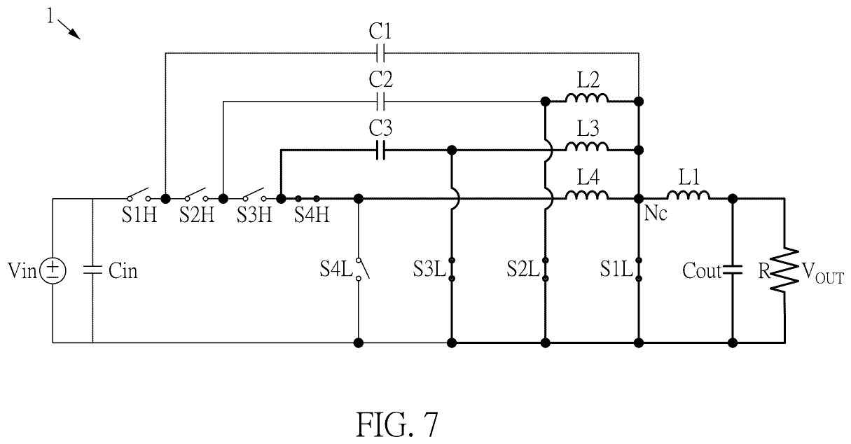

FIG. 7 is a schematic diagram showing current flow paths of the single-stage non-isolated buck converter in a seventh phase according to one embodiment of the present disclosure.

The seventh phase (time t6-t7): as shown in FIG. 7, during this time interval, the switch control circuit 16 enters the fourth operating mode, the high-side switch S4H is turned on, and the high-side switches S1H, S2H, and S3H are turned off. On the other hand, the low-side switch S4L is turned off, and the low-side switches S1L, S2L, and S3L are turned on. The main inductor L1 is continuously demagnetized by the negative output voltage VOUT, and the voltage stress on the additional inductors L2 and L3 is zero, causing the current on the additional inductors L2 and L3 to circulate. The additional inductor L4 is charged by the clamping capacitor C3, while the capacitors C1 and C2 are turned off, as shown in equations (24) to (28):

$${v}_{L 1} = {L}_{1} \frac{d {i}_{L 1}}{d t} = - {V}_{OUT} ; \qquad ( 24 )$$

$${v}_{L 2} = {L}_{2} \frac{d {i}_{L 2}}{d t} = 0 ; \qquad ( 25 )$$

$${v}_{L 3} = {L}_{3} \frac{d {i}_{L 3}}{d t} = 0 ; \qquad ( 26 )$$

$${v}_{L 4} = {L}_{4} \frac{d {i}_{L 4}}{d t} = {V}_{C 3} ; \qquad ( 27 )$$

$${i}_{C 3} = {C}_{3} \frac{{dv}_{C 3}}{d t} = - {i}_{L 4} ; \qquad ( 28 )$$

After the seventh phase (time t6-t7) ends, the eighth stage as shown in FIG. 4 is entered, and the switch control circuit 16 enters the second operating mode. Finally, the above first to eighth phases are repeated.

A steady-state analysis of the single-stage non-isolated buck converter 1 according to one embodiment of the present disclosure is illustrated hereinafter. Regarding a voltage conversion ratio and a voltage stress, by applying voltage-second balancing on the main inductor L1 and the additional inductors L2, L3 and L4 within one switching cycle, the relevant equation (29) can be expressed as follows:

$$\{ \begin{matrix}{v}_{L 1} \vert {T}_{S} = {DT}_{S} ( {V}_{IN} - {V}_{C 1} - {V}_{OUT} ) + ( 1 - D ) {T}_{S} ( - {V}_{OUT} ) = 0 \\ {v}_{L 2} \vert {T}_{S} = {DT}_{S} ( - {V}_{IN} + {V}_{C 1} ) + {DT}_{S} ( {V}_{C 1} - {V}_{C 2} ) = 0 \\ {v}_{L 3} \vert {T}_{S} = {DT}_{S} ( - {V}_{IN} + {V}_{C 1} ) + {DT}_{S} ( {V}_{C 2} - {V}_{C 3} ) = 0 \\ {v}_{L 4} \vert {T}_{S} = {DT}_{S} ( - {V}_{IN} + {V}_{C 1} ) + {DT}_{S} ( {V}_{C 3} ) = 0\end{matrix} ; \qquad ( 29 )$$

Therefore, a relationship between the output voltage VOUT and the input voltage VIN can be described as follows:

$${V}_{out} = \frac{{DV}_{IN}}{4} ; \qquad ( 30 )$$

A voltage gain can be expressed as equation (31):

$$A = \frac{{V}_{OUT}}{{V}_{IN}} = \frac{D}{4} ; \qquad ( 31 )$$

In addition, the voltage of the clamping capacitor can be obtained by the following equation (32):

$$\{ \begin{matrix}{V}_{C 1} = {V}_{IN} - \frac{{V}_{OUT}}{D} = \frac{3}{4} {V}_{IN} \\ {V}_{C 2} = {V}_{IN} - \frac{2 {V}_{OUT}}{D} = \frac{1}{2} {V}_{IN} \\ {V}_{C 3} = {V}_{IN} - \frac{3 {V}_{OUT}}{D} = \frac{1}{4} {V}_{IN}\end{matrix} . \qquad ( 32 )$$

Equation (32) shows that the clamping capacitor voltages VC1, VC2, and VC3 are ¾, ½, and ¼ of the input voltage, respectively, and that the voltage ratio is reduced by four times. This means that at the same duty cycle D, the voltage ratio can be controlled to be four times higher than that of the conventional buck converter. In addition, the clamping capacitors C1, C2, and C3 store energy from the input side, thereby reducing the voltage stress on the switches. From equation (32) and FIGS. 3 to 7, it can be seen that the voltage stress V_{DS1H}, V_{DS2H}, V_{DS3H}, V_{DS4H}, V_{DS1L}, V_{DS2L}, V_{DS3L}, V_{DS4L} of the switches during the switching cycle can be obtained by the following equation:

$${V}_{DS 1 H} = \{ \begin{matrix}0 & S 1 H = 1 , S 1 L = 0 \\ \frac{1}{4} {V}_{IN} & S 1 H = 0 , S 1 L = 1\end{matrix} ; \qquad ( 33 )$$

$${V}_{DSL . i ( i = 1 , 2 , 3 , 4 )} = \{ \begin{matrix}0 & S {H}_{i} = 0 , S {L}_{i} = 1 \\ \frac{1}{4} {V}_{IN} & S {H}_{i} = 1 , {SL}_{i} = 0\end{matrix} ; \qquad ( 34 )$$

$${V}_{DS 2 H} = \{ \begin{matrix}\frac{1}{2} {V}_{IN} & S 1 H = 1 , S 1 L = 0 \\ \frac{1}{4} {V}_{IN} & S 1 L = S 2 L = 1 , S 1 H = S 2 H = 0 \\ 0 & S 2 H = 1 , S 2 L = 0\end{matrix} ; \qquad ( 35 )$$

$${V}_{DS 3 H} = \{ \begin{matrix}\frac{1}{2} {V}_{IN} & S 2 H = 1 , S 2 L = 0 \\ \frac{1}{4} {V}_{IN} & S 2 L = S 3 L = 1 , S 2 H = S 3 H = 0 \\ 0 & S 3 H = 1 , S 3 L = 0\end{matrix} ; \qquad ( 36 )$$

$${V}_{DS 4 H} = \{ \begin{matrix}\frac{1}{2} {V}_{IN} & S 3 H = 1 , S 3 L = 0 \\ \frac{1}{4} {V}_{IN} & S 3 L = S 4 L = 1 , S 3 H = S 4 H = 0 \\ 0 & S 4 H = 1 , S 4 L = 0\end{matrix} ; \qquad ( 37 )$$

As shown in equations (33), (34), (35), (36), and (37), due to the presence of the clamping capacitor, the voltage stress on the switches is lower than that of the conventional buck converter. Therefore, due to the reduced voltage stress on these switches, the selection of switches becomes more flexible. In addition, low-voltage switches exhibit lower on-resistance than high voltage switches, which reduces conduction losses. Therefore, for high voltage ratio applications, efficiency and cost can be improved.

Referring to FIG. 2 again, FIG. 2 shows the inductor current waveforms of the main inductor L1 and the additional inductors L2, L3, and L4 during the switching period Ts. As shown in the analysis of equations (1), (13), (20), and (27), the peak-to-peak inductor current ΔI_{L1} can be expressed as:

$$\{ \begin{matrix}Δ {I}_{L 1} = \frac{( {V}_{IN} - {V}_{C 1} - {V}_{OUT} ) D {T}_{S}}{{L}_{1}} \\ Δ {I}_{L i} = Δ {I}_{L i} = Δ {I}_{L i} = \frac{( - {V}_{IN} + {V}_{C 1} ) D {T}_{S}}{{L}_{i}} , i = 2 , 3 , 4\end{matrix} . \qquad ( 38 )$$

Based on the previous analysis of each time period, ampere-second balance is applied to the clamping capacitor:

$$\{ \begin{matrix}{i}_{C 1} \vert {T}_{S} = D {T}_{S} ( {i}_{L 1} - {i}_{L 2} - {i}_{L 3} - {i}_{L 4} ) + D {T}_{S} ( - {i}_{L 2} ) = 0 \\ {i}_{C 2} \vert {T}_{S} = D {T}_{S} ( {i}_{L 2} ) + D {T}_{S} ( - {i}_{L 3} ) = 0 \\ {i}_{C 3} \vert {T}_{S} = D {T}_{S} ( {i}_{L 3} ) + D {T}_{S} ( - {i}_{L 4} ) = 0\end{matrix} . \qquad ( 39 )$$

From equation (39), an average inductor current can be expressed as:

$$\{ \begin{matrix}{I}_{L 1} = {I}_{OUT} = \frac{{V}_{OUT}}{R} \\ {I}_{L 2} = {I}_{L 3} = {I}_{L 4} = \frac{{I}_{OUT}}{4} = \frac{{V}_{OUT}}{4 R}\end{matrix} . \qquad ( 40 )$$

Since the average inductor currents of inductors L2, L3, and L4 are equal, the same inductance can be chosen. Therefore, the minimum and maximum values of these inductor currents are obtained as:

$$\{ \begin{matrix}{I}_{L 1 \_ min} = {I}_{OUT} - \frac{Δ {I}_{L 1}}{2} \\ {I}_{L 1 \_ max} = {I}_{OUT} + \frac{Δ {I}_{L 1}}{2} \\ {I}_{L 2 \_ min} = {I}_{L 3 \_ min} = {I}_{L 4 \_ min} = \frac{{I}_{OUT}}{4} - \frac{Δ {I}_{L 2 , 3 , 4}}{2} \\ {I}_{L 2 \_ max} = {I}_{L 3 \_ max} = {I}_{L 4 \_ max} = \frac{{I}_{OUT}}{4} + \frac{Δ {I}_{L 2 , 3 , 4}}{2}\end{matrix} . \qquad ( 41 )$$

The operating condition of the main inductor is:

$$\{ \begin{matrix}2 {I}_{L 1} \geq Δ {I}_{L 1} , \to CCM \\ 2 {I}_{L 1} < Δ {I}_{L 1} , \to DCM\end{matrix} . \qquad ( 42 )$$

Equation (40) is substituted into equation (42) to obtain the following equation:

$$\{ \begin{matrix}2 {I}_{OUT} \geq Δ {I}_{L 1} , \to CCM \\ 2 {I}_{OUT} < Δ {I}_{L 1} , \to DCM\end{matrix} . \qquad ( 43 )$$

According to equations (41) and (43), the main inductor L1, the additional inductors L2, L3 and L4 can be independently designed to operate in CCM or discontinuous current mode (DCM).

From equation (43), a boundary condition L_{1_boundary} of each inductor can be obtained:

$${L}_{1 \_ boundary} = \frac{( {V}_{IN} - {V}_{C 1} - {V}_{OUT} ) D {T}_{S}}{2 {I}_{OUT}} . \qquad ( 44 )$$

According to equation (44), if the inductance is higher than the boundary condition, the single-stage non-isolated buck converter 1 will operate in CCM mode, otherwise the single-stage non-isolated buck converter 1 will operate in transient current mode (TCM) mode.

FIG. 7 is a schematic diagram showing current flow paths of the single-stage non-isolated buck converter in a seventh phase according to one embodiment of the present disclosure. From FIG. 5 and the previous analysis, the current stress of the switch (the subscript indicates the corresponding high-side switch or low-side switch) can be expressed as:

$$\{ \begin{matrix}{i}_{S 1 H} = ( {i}_{L 1} - {i}_{L 2} - {i}_{L 3} - {i}_{L 4} ) S 1 H \\ {i}_{S 1 L} = ( ( {i}_{L 1} - {i}_{L 2} - {i}_{L 3} - {i}_{L 4} ) S 2 L + ( {i}_{L 1} - {i}_{L 3} - {i}_{L 4} ) S 2 H ) S 1 L\end{matrix} ; \qquad ( 45 )$$

$$\{ \begin{matrix}{i}_{S 2 H} = {i}_{L 2} S 2 H \\ {i}_{S 2 L} = ( {i}_{L 2} S 3 L + ( {i}_{L 2} + {i}_{L 3} ) S 3 H ) S 2 L\end{matrix} ; \qquad ( 46 )$$

$$\{ \begin{matrix}{i}_{S 3 H} = {i}_{L 3} S 3 H \\ {i}_{S 3 L} = ( {i}_{L 3} S 4 L + ( {i}_{L 3} + {i}_{L 4} ) S 4 H ) S 3 L\end{matrix} ; \qquad ( 47 )$$

$$\{ \begin{matrix}{i}_{S 4 H} = {i}_{L 4} S 4 H \\ {i}_{S 4 L} = ( {i}_{L 4} S 4 H ) S 4 L\end{matrix} ; \qquad ( 48 )$$

where SiH is a state of the high-side switch and SiL is a state of the low-side switch. From the operation of FIGS. 3 to 7 and the current stress equation above, the current stress of each switch is a sum of the phase-shifted inductor currents. However, since the current is shared by connecting parallel inner inductors, this current stress is not very high compared to the conventional buck converter operating under the same conditions.

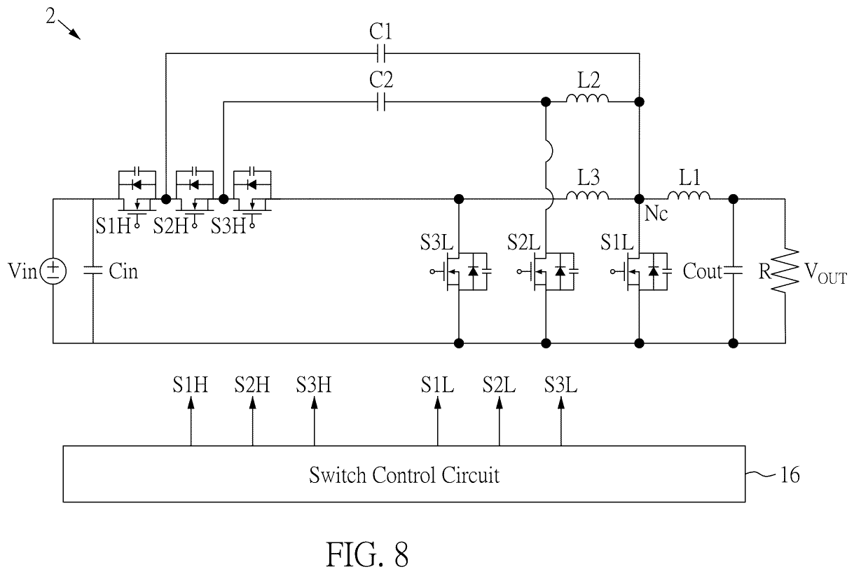

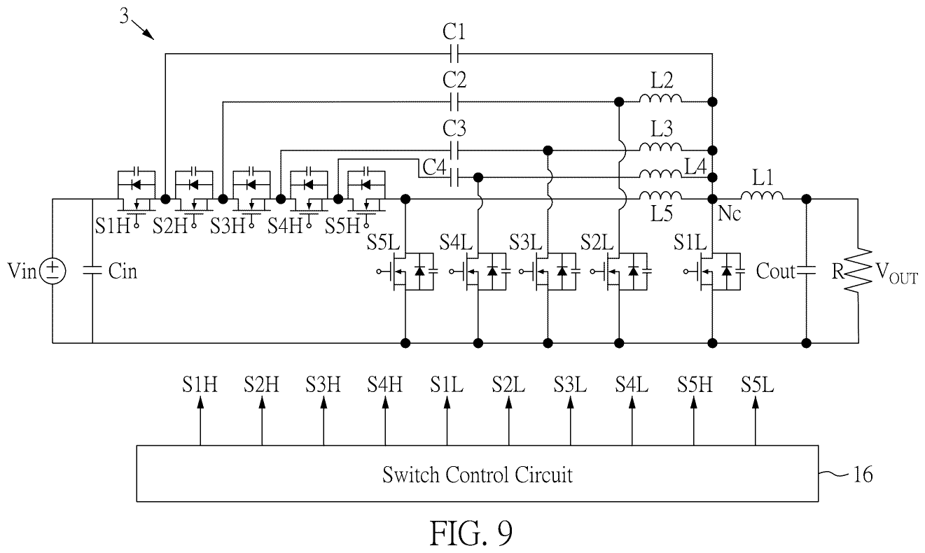

FIG. 8 is a circuit diagram of a single-stage non-isolated buck converter according to another embodiment of the present disclosure, and FIG. 9 is a circuit diagram of a single-stage non-isolated buck converter according to yet another embodiment of the present disclosure.

Single-stage non-isolated buck converters 2 and 3 derived from FIG. 1 are shown in FIG. 8 and FIG. 9, respectively. In the single-stage non-isolated buck converter 2 of FIG. 8, a switching network of order three is adopted. The high-side switches S1H, S2H, and S3H are phase-shifted by 120° with respect to one another, and the low-side switches S1L, S2L, and S3L are complementary switches of the high-side switches S1H, S2H, and S3H, respectively.

The five-order switch network is shown in FIG. 9, in which a third one of the second switch circuits is further provided, including a high-side switch S4H, an additional inductor L4 and a low-side switch S4L, and the connection relationship of the third switch circuit is the same as that of FIG. 1, except that reference numerals are modified to be a high-side switch S5H, a low-side switch S5L and an additional inductor L5. Since the switching network is of fifth order (m is 3, N is 5), the high-side switches S1H, S2H, S3H, S4H and S5H are 72 degrees phase-shifted from one another, and switches S1L, S2L, S3L, S4L, S5L are the complementary switches of switches S1H, S2H, S3H, S4H and S5H respectively. For a switch network with N layers (note that N is m+2), the following conditions need to be ensured:

1. Duty ratio:

$$D \leq \frac{1}{N} .$$

2. Switching signals of the switches SH, i (i=1, 2, 3, . . . , N) are phase-shifted by

$$\frac{360 °}{N} .$$

Therefore, the switch voltage stress and average inductor current of the Nth order can be expressed as:

$${V}_{DS 1 H} = {V}_{D S L , n} = \frac{1}{N} {V}_{IN} ; \qquad ( 49 )$$

$${V}_{D S H , i} = \frac{2}{N} {V}_{IN} ; \qquad ( 50 )$$

$$\{ \begin{matrix}{I}_{L 1} = {I}_{OUT} = \frac{{V}_{OUT}}{R} \\ {I}_{L , i} = \frac{{I}_{OUT}}{N} = \frac{{V}_{OUT}}{N R}\end{matrix} ; \qquad ( 51 )$$

$${V}_{C , i i} = \frac{N - i i}{N} {V}_{IN} ; \qquad ( 52 )$$

$$\frac{{V}_{OUT}}{{V}_{IN}} = \frac{D}{N} ; \qquad ( 53 )$$

where N is the order of the switching network, i is the i-th order from 2 to N, and ii is the ii-th order from 1 to N. As the order of the switching network increases, the voltage ratio increases. From equations (49), (50) and (52), it can be seen that as the order of the switching network increases, the voltage drops on the clamping capacitors will increase and the voltage stress on the switches will decrease, thereby reducing the switching loss. From the above analysis, it can be seen that the high-side switch S1H and the low-side switch S1L will carry more current from the inductor, but because the voltage stress is lower than other switches, the efficiency can be balanced. The order of the switching network can be selected based on the application, voltage conversion ratio, and efficiency requirements.

### Beneficial Effects of the Embodiments

In conclusion, in the single-stage non-isolated buck converter, compared with the switch network of the traditional buck converter, clamping capacitors are added to reduce the voltage stress on the switches and the input voltage. In addition to the main inductor that transfers energy to the output, additional inductors are used to alleviate the burden on the clamping capacitors. Switch selection remains manageable even at high voltage gains, and the voltage stress on these switches can be controlled by adjusting an order of the switch network. Additionally, the use of low-voltage switches, which do not require high voltage tolerance, results in smaller on-resistance and thus reduces conduction losses. Furthermore, under high voltage gain requirements, compliance can be achieved by increasing the order of the switch network.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A single-stage non-isolated buck converter, comprising:
an input capacitor, a first end and a second end of the input capacitor being respectively connected to a first end and a second end of an input power source;
an output capacitor, a first end and a second end of the output capacitor being respectively connected to a first end and a second end of a load;
a main inductor connected between a common node and the first end of the output capacitor;
a first switching circuit including:
a first high-side switch, a first end of the first high-side switch being connected to the first end of the input capacitor;
a first clamping capacitor connected between the second end of the first high-side switch and the common node; and
a first low-side switch connected between the common node and the second end of the output capacitor;
one or more second switch circuits, each including:
a second high-side switch having a first end and a second end and being connected between the second end of the first high-side switch and the common node;
a second clamping capacitor, a first end of the second clamping capacitor being connected to the second end of the second high-side switch;
a first additional inductor, a first end and a second end of the first additional inductor being respectively connected to the second end of the second clamping capacitor and the common node; and
a second low-side switch connected between the first end of the first additional inductor and the second end of the output capacitor;
a third switch circuit including:
a third high-side switch, a first end of the third high-side switch being connected to the second end of one of the second high-side switches;
a third low-side switch, a first end and a second end of the third low-side switch being respectively connected to the second end of the third high-side switch and the second end of the output capacitor; and
a second additional inductor, a first end of the second additional inductor being connected to the second end of the third high-side switch, the first end of the third low-side switch and the common node; and
a switch control circuit configured to control the first high-side switch, the first low-side switch, each of the second high-side switches, each of the second low-side switches, the third high-side switch and the third low-side switch to be turned on and off in a plurality of operating modes.

2. The single-stage non-isolated buck converter according to claim 1, wherein switch states of the first high-side switch and the first low-side switch are complementary, switch states of the second high-side switches are respectively complementary to switch states of the second low-side switches, and switch states of the third high-side switch and the third low-side switch are complementary.

3. The single-stage non-isolated buck converter according to claim 2, wherein the plurality of operating modes include a first operating mode, in which the switch control circuit controls the first high-side switch to be turned on, the first low-side switch to be turned off, each of the second high-side switches to be turned off, and each of the second high-side switches to be turned on.

4. The single-stage non-isolated buck converter according to claim 3, wherein the plurality of operating modes include a second operating mode, in which the switch control circuit controls the first high-side switch to be turned off, the first low-side switch to be turned on, each of the second high-side switches to be turned off, each of the second high-side switches to be turned on, the third high-side switch to be turned off, and the third low-side switch to be turned on.

5. The single-stage non-isolated buck converter according to claim 4, wherein the plurality of operating modes include m third operating modes, and in an n-th third operating mode among the m third operating modes, the switch control circuit controls the first high-side switch to be turned off, the first low-side switch to be turned on, the second high-side switch of an n-th one of the second switch circuits to be turned on and the second high-side switches of the remaining second switch circuits to be turned off, the second low-side switch of the n-th one of the second switch circuits to be turned off and the second high-side switches of the remaining second switch circuits to be turned off, the third high-side switch to be turned off, and the third low-side switch to be turned on.

6. The single-stage non-isolated buck converter according to claim 5, wherein a quantity of the one or more second switching circuits is m, and n, m are positive integers greater than zero, and n is within a range from 1 to m.

7. The single-stage non-isolated buck converter according to claim 6, wherein the plurality of operating modes include a fourth operating mode, in which the switch control circuit controls the first high-side switch to be turned off, the first low-side switch to be turned on, the second high-side switches to be turned off, the second high-side switches to be turned on, the third high-side switch to be turned on, and the third low-side switch to be turned off.

8. The single-stage non-isolated buck converter according to claim 7, wherein the switch control circuit sequentially enters the first operating mode, the second operating mode, m third operating modes, the second operating mode, the fourth operating mode and the second operating mode.

9. The single-stage non-isolated buck converter according to claim 8, wherein the switch control circuit further enters the second operating mode between two of the m third operating modes.

10. The single-stage non-isolated buck converter according to claim 9, wherein the first high-side switch, the m second high-side switches and the third high-side switch are phase-shifted by 360°/(m+2) with respect to one another.
